(19) United States
(12) Patent Application Publication
(10) Pub. No.: US 2018/0150146 A1
(43) Pub. Date: May 31, 2018

(54) MAGNETIC SUSPENSION MOUSE HAVING RFID SENSOR ARRAY

(71) Applicant: Man Chiu WONG, Hong Kong (HK)

(72) Inventor: Man Chiu WONG, Hong Kong (HK)

(21) Appl. No.: 15/404,430

(22) Filed: Jan. 12, 2017

(30) Foreign Application Priority Data
Nov. 30, 2016 (CN) 201611079913.2

(51) Int. Cl. G06F 3/0346; G06F 3/0354; G06F 3/038; G06K 19/07

(52) U.S. Cl. CPC G06F 3/0346; G06K 19/0727; G06F 3/038; G06F 3/03544

(57) ABSTRACT

The present invention relates to a magnetic suspension mouse having a RFID sensor array, comprising a mouse tray and a mouse body. A magnetic coil, a displacement sensor, a microcontroller and a magnetic force controller are fixedly disposed inside a cavity of the mouse tray. The displacement sensor is disposed at a top wall of the cavity of the mouse tray. A RFID sensor array is fixedly disposed on top of the mouse tray. The mouse body is disposed on top of the mouse tray, the mouse body comprising a housing, a hemispherical magnet fixedly disposed inside a cavity of the housing, and a first RFID identifier, a second RFID identifier and a third RFID identifier disposed from top to bottom of a surface of the housing. The mouse has the advantages of having a simple and logical structure, convenient to use and highly smart, and is able to effectively solve the existing problem of the mouse relying on an external surface.

### BACKGROUND OF INVENTION

The present invention relates to the field of computer accessories, in particular to a magnetic suspension mouse having a RFID sensor array.

With the widespread popularity of computers, mouse is the most common computer accessory being used among known technologies. However, mouse has a disadvantage that it is unable to be operated while suspended, and can only be operated when in contact with a surface. In operation of the mouse, the hand continuously rubs and presses against the working surface of the mouse, easily leading to hand fatigue or symptoms that affects user health. Therefore, a mouse that does not need to rely on a surface is needed.

### SUMMARY OF INVENTION

The technical problem to be solved by the present invention is: to overcome the aforementioned problem, a magnetic suspension mouse having a RFID sensor array is provided. The mouse has the advantages of having a simple and logical structure, convenient to use and highly smart, and is able to effectively solve the existing problem of the mouse relying on an external surface.

The technical solution used in the present invention to solve the technical problem is: a magnetic suspension mouse having a RFID sensor array, comprising a mouse tray and a mouse body, the mouse tray having a hollow disc structure. A magnetic coil, a displacement sensor, a microcontroller and a magnetic force controller are fixedly disposed inside a cavity of the mouse tray. The displacement sensor is disposed at a top wall of the cavity of the mouse tray, with a measuring end thereof penetrating through a top surface of the mouse tray. A RFID sensor array is fixedly disposed on top of the mouse tray.

The mouse body is disposed on top of the mouse tray, the mouse body comprising a housing, a hemispherical magnet fixedly disposed inside a cavity of the housing, and a first RFID identifier, a second RFID identifier and a third RFID identifier disposed from top to bottom of a surface of the housing.

In a further embodiment, the magnetic coil is a disc structure fixedly disposed on the top surface of the cavity of the mouse tray. A shield is disposed on a side of the magnetic coil facing the mouse tray cavity.

In a further embodiment, the first RFID identifier, the second RFID identifier and the third RFID identifier are ring structures all parallel to each other.

In a further embodiment, the microcontroller is electrically connected to the magnetic force controller and the displacement sensor.

In a further embodiment, the magnetic force controller is electrically connected to the magnetic coil.

In a further embodiment, the microcontroller is electrically connected to an external power supply.

In a further embodiment, a cushion pad is disposed on the mouse body.

The advantage of the present invention is: a magnetic suspension mouse with RFID sensor array, comprising a mouse tray and a mouse body. The RFID sensor array is disposed on top of the mouse tray. The mouse body is disposed on top of the mouse tray, with RFID identifiers disposed on the mouse body. A hemispherical magnet is fixedly disposed inside a cavity of the mouse body. The mouse body is directedly suspended above the mouse tray through operation of a magnetic coil and a magnetic force controller disposed on the mouse tray. RFID sensor array can detect a direction of movement of the mouse through scanning the RFID identifiers on the mouse body, as such can function as a mouse cursor without moving the present invention on an external surface, and can further operate while suspended in the air. The mouse has the advantages of having a simple and logical structure, convenient to use and highly smart, and is able to effectively solve the existing problem of the mouse relying on an external surface.

### BRIEF DESCRIPTION OF DRAWINGS

The present invention is further explained below with the accompanying drawings and embodiments.

FIG. 1 is an overall structural schematic diagram of a magnetic suspension mouse having RFID sensor array according to the present invention.

FIG. 2 is an cross sectional diagram of a mouse body of a magnetic suspension mouse having RFID sensor array according to the present invention.

Legends in the drawings: 1 mouse tray, 11 magnetic coil, 111 shield, 12 displacement sensor, 13 microcontroller, 14 magnetic force controller, 15 RFID sensor array, 2 mouse body, 21 first RFID identifier, 22 second RFID identifier, 23 third RFID identifier, 24 housing, 25 hemispherical magnet, 26 cushion pad.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

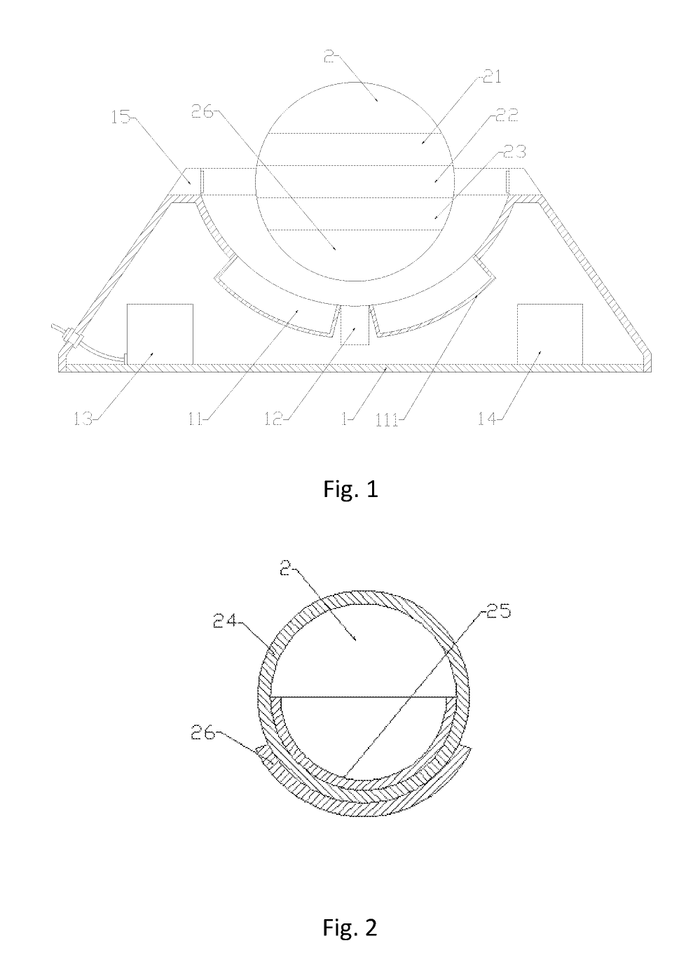

A magnetic suspension mouse having RFID sensor array as shown in FIG. 1 comprises a mouse tray 1 and a mouse body 2. The mouse tray 1 has a hollow disc structure. Magnetic coil 11, displacement sensor 12, microcontroller 13, and magnetic force controller 14 are fixedly disposed inside a cavity of the mouse tray 1. A RFID sensor array 15 is fixedly disposed on top of the mouse tray 1. The displacement sensor 12 is disposed at a top wall of the cavity of the mouse tray 1, with a measurement end of the displacement sensor 12 penetrating through the top surface of the mouse tray 1. The magnetic coil 11 is a disc structure fixedly disposed at a top wall of the cavity of the mouse tray 1. A shield 111 is further disposed at a side of the magnetic coil 11 facing the cavity of the mouse tray 1, for preventing magnetic coil 11 affecting the normal operation of other electronic devices.

As shown in FIG. 2, the mouse body 2 is disposed on top of the mouse tray 1. The mouse body 2 comprises a housing 24 having a hollow structure, a hemispherical magnet 25 disposed inside a cavity of the housing 24, and first RFID identifier 21, second RFID identifier 22 and third RFID identifier 23 disposed on a surface of the housing 24 from top to bottom.

The displacement sensor 12 senses the height of suspension of the mouse body 2, to allow the RFID sensor array 15 to scan the RFID identifiers. When the RFID sensor array 15 is unable to scan the RFID identifiers, the microcontroller 13 controls the magnetic coil 11 through the magnetic force controller 14 to raise or lower the height of the mouse body 2.

The microcontroller 13 is electrically connected to the magnetic force controller 14 and the displacement sensor 12 separately, the magnetic force controller 14 is electrically connected to the magnetic coil 11.

In a feasible embodiment, the magnetic coil 11 is replaced by a bowl-shaped magnet array. The bowl-shaped magnet array is made of several fan-shaped magnets orienting towards a same direction but with different polarities, shielding is done between magnets. The mouse body 2 is suspended above the mouse tray due to the magnetic force between the hemispherical magnet 25 and the bowl-shaped magnet array.

In an embodiment, the RFID sensor array 15 is disposed at an opening of the mouse tray 1, and positioned in a disc shape along the opening, the first RFID identifier 21, the second RFID identifier 22 and the third RFID identifier 23 are ring shaped structures all parallel to each other. In another embodiment, the RFID sensor array 15 is disposed on the mouse tray 1 at an angle, the first RFID identifier 21, the second RFID identifier 22 and the third RFID identifier 23 are disposed at the face of the mouse body 2 facing the mouse tray 1 at the same angle and in a crossing pattern.

In an embodiment, the microcontroller 13 is electrically connected to an external power source. In another embodiment, a lithium battery is disposed inside the cavity of the mouse tray 1, the microcontroller 13 is electrically connected to the lithium battery, and a charging connector for the lithium battery is disposed at the mouse tray 1.

In an embodiment, a cushion pad 26 is disposed on the mouse body 2, and in another embodiment, a cushion pad is disposed on the mouse tray.

The magnetic suspension mouse with RFID sensor array comprises a mouse tray and a mouse body. The RFID sensor array is disposed on top of the mouse tray. The mouse body is disposed on top of the mouse tray, with RFID identifiers disposed on the mouse body. A hemispherical magnet is fixedly disposed inside a cavity of the mouse body. The mouse body is directedly suspended above the mouse tray through operation of a magnetic coil and a magnetic force controller disposed on the mouse tray. RFID sensor array can detect a direction of movement of the mouse through scanning the RFID identifiers on the mouse body, as such can function as a mouse cursor without moving the present invention on an external surface, and can further operate while suspended in the air. The mouse has the advantages of having a simple and logical structure, convenient to use and highly smart, and is able to effectively solve the existing problem of the mouse relying on an external surface.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. A magnetic suspension mouse having a RFID sensor array, comprising a mouse tray and a mouse body, the mouse tray having a hollow disc structure; a magnetic coil, a displacement sensor, a microcontroller and a magnetic force controller are fixedly disposed inside a cavity of the mouse tray; the displacement sensor is disposed at a top wall of the cavity of the mouse tray, with a measuring end thereof penetrating through a top surface of the mouse tray; a RFID sensor array is fixedly disposed on top of the mouse tray;
the mouse body is disposed on top of the mouse tray, the mouse body comprising a housing, a hemispherical magnet fixedly disposed inside a cavity of the housing, and a first RFID identifier, a second RFID identifier and a third RFID identifier disposed from top to bottom of a surface of the housing;
the magnetic coil is a disc structure fixedly disposed on the top surface of the cavity of the mouse tray; a shield is disposed on a side of the magnetic coil facing the mouse tray cavity; the first RFID identifier, the second RFID identifier and the third RFID identifier are ring structures all parallel to each other.

2. The magnetic suspension mouse having a RFID sensor array according to claim 1, characterized in that: the microcontroller is electrically connected to the magnetic force controller and the displacement sensor.

3. The magnetic suspension mouse having a RFID sensor array according to claim 1, characterized in that: the magnetic force controller is electrically connected to the magnetic coil.

4. The magnetic suspension mouse having a RFID sensor array according to claim 1, characterized in that: the microcontroller is electrically connected to an external power supply.

5. The magnetic suspension mouse having a RFID sensor array according to claim 1, characterized in that: a cushion pad is disposed on the mouse body.
